(19) United States
(12) Patent Application Publication
(10) Pub. No.: US 2018/0099525 A1
(43) Pub. Date: Apr. 12, 2018

(54) MULTIPURPOSE ROLLABLE MOVING DEVICE

(71) Applicants: HYUNDAI MOTOR COMPANY, Seoul (KR); KIA MOTORS CORPORATION, Seoul (KR)

(72) Inventors: Nam Gyun KIM, Incheon (KR); Kyung Ho YOO, Seoul (KR); Jae Suk SEO, Seoul (KR); Yong Uk SEO, Seoul (KR); Young A JUNG, Seoul (KR); Hong Gyun LIM, Suwon-si, Gyeonggi-do (KR); Joo Seon YOO, Incheon (KR)

(73) Assignees: HYUNDAI MOTOR COMPANY, Seoul (KR); KIA MOTORS CORPORATION, Seoul (KR)

(21) Appl. No.: 15/699,590

(22) Filed: Sep. 8, 2017

(30) Foreign Application Priority Data
Oct. 6, 2016 (KR) 10-2016-0129163

(51) Int. Cl. B60B 19/00; B62D 57/00; B60B 19/14; A63H 33/00; A63B 43/04

(52) U.S. Cl. CPC B60B 19/006; B62D 57/00; A63B 43/04; A63H 33/005; B60B 19/14

(57) ABSTRACT

A multipurpose rollable moving device is provided. The multipurpose rollable moving device includes: a spherical driving wheel; a driving device that is installed within the driving wheel in order to apply a torque to the spherical driving wheel; a docking portion that is installed within the spherical driving wheel to generate a magnetic force; and a mounting portion that may be attached to a surface of the spherical driving wheel by a magnetic force of the docking portion and that may mount an article. Therefore, the multipurpose rollable moving device can mount an article and easily stably move in an omnidirection on the ground.

### CROSS-REFERENCE TO RELATED APPLICATION

This application claims priority to and the benefit of Korean Patent Application No. 10-2016-0129163, filed on Oct. 6, 2016, which is incorporated herein by reference in its entirety.

### FIELD

The present disclosure relates to a multipurpose rollable moving device. More particularly, the present disclosure relates to a multipurpose rollable moving device that can rolling move by self-propelling in an omnidirection (entire direction).

### BACKGROUND

The statements in this section merely provide background information related to the present disclosure and may not constitute prior art.

Nowadays, a flight vehicle such as a drone may transfer an article or a camera may be mounted in the drone and photograph an image. The drone may be used with a multipurpose, but because such a drone is a flight vehicle, the drone may not be used on the ground and thus its use is limited.

Accordingly, a self-propelling moving apparatus that is capable of mounting an article on the ground and appropriately delivering the article to a wishing position is developed and suggested in the art, for example, Korean Patent Publication No. 10-2016-0016830, titled “Multipurpose self-propelled device”.

In the technology, a self-propelled driving system is housed within a spherical wheel, a payload space that may mount a small article is provided within the spherical wheel, and thus a small article may be mounted within the spherical wheel to be transferred by a self-propelled driving system.

However, in the technology, because a payload space is provided within a limited spherical wheel, a kind of articles that can mount is limited and the self-propelled driving system is not thus widely used.

The above information disclosed in this Background section is only for enhancement of understanding of the background of the present disclosure and therefore it may contain information that does not form the prior art that is already known to a person of ordinary skill in the art.

### SUMMARY

The present disclosure provides a multipurpose rollable moving device having advantages of being capable of easily moving in an ommidirection regardless of a topography form at the ground, mounting various kinds of articles regardless of a size and kind of an article, and using as a smart mobility device.

An example form of the present disclosure provides a multipurpose rollable moving device including: a spherical driving wheel; a driving device that is installed within the spherical driving wheel and configured to apply a torque to the spherical driving wheel; a docking portion that is installed within the spherical driving wheel and configured to generate a magnetic force; and a mounting portion attached to a surface of the spherical driving wheel by a magnetic force of the docking portion and configured to mount an article.

In the mounting portion, a plurality of magnets configured to mutually operate with the magnetic force of the docking portion is provided.

The driving device may include: a plurality of omni wheels; and a drive motor coupled to each of the plurality of omni wheels and configured to drive the plurality of omni wheels.

The plurality of omni wheels may include: first and second wheel housings each having a circular plate shape; and a plurality of first and second rollers that are rotatably mounted in the each of the first and second wheel housings.

The first and second wheel housings may be disposed in an axial direction to form a two-fold housing, in the first wheel housing, the plurality of first rollers may be arranged at predetermined intervals in a circumference direction, in the second wheel housing, the plurality of second rollers may be arranged at predetermined intervals in a circumference direction, and the second rollers may be disposed one by one between the plurality of first rollers.

In each of the plurality of omni wheels, an encoder configured to detect a rotation speed may be installed.

The docking portion may include: a docking housing; a plurality of magnets that is mounted at an upper portion of the docking housing and configured to generate the magnetic force; a support shaft that is inserted into and configured to support the docking housing; and a spring configured to elastically support the support shaft.

The docking portion may be mounted on a first mounting plate; in a central portion of the inside of the spherical driving wheel, a second mounting plate may be disposed; and the first mounting plate may be connected with the second mounting plate through a plurality of bridges.

In the second mounting plate, a plurality of ball castors may be installed at predetermined intervals in a circumference direction.

A plurality of receiving grooves may be formed at predetermined intervals in a circumference direction of the second mounting plate, and at least one ball castors of the plurality of ball castors is housed in each of the plurality of receiving grooves.

A third mounting plate may be disposed under the second mounting plate, and the driving device may be mounted and supported on the third mounting plate.

A battery pack may be installed at the center of a lower surface of the third mounting plate, and configured to supply power to the driving device and be charged the outside.

The mounting portion may include: a mounting housing; the plurality of magnets that are received within the mounting housing; and a plurality of ball castors mounted at a lower surface of the mounting housing and configured to contact a surface of the spherical driving wheel.

The multipurpose rollable moving device may further include an identification element configured to identify an object that is mounted in the mounting portion.

The multipurpose rollable moving device may further include a main controller configured to identify the object by communicating with the identification element through wire and wireless communication modules, and the main controller may diagnose a charge state of the battery pack.

In the mounting portion, a camera may be mounted, and the main controller may determine a surrounding situation through the camera and is configured to control the driving device.

The multipurpose rollable moving device may further include a drive controller configured to control the drive motor, and the drive controller may be connected with a motor driver of the drive motor and configured to control a driving speed and driving direction of the drive motor.

The multipurpose rollable moving device may further include an acceleration sensor, and the drive controller may determine a rolling moving speed of the driving wheel through the acceleration sensor to control the drive motor.

The multipurpose rollable moving device may further include a gyro sensor, and the drive controller may determine a roll rate signal through the gyro sensor to control a posture of the spherical driving wheel.

The battery pack may be received within a trunk room of a vehicle to be charged by wireless communication with a wireless charge panel of the vehicle.

In a multipurpose rollable moving device according to an exemplary form of the present disclosure, the multipurpose rollable moving device can move in an omnidirection (i.e., all directions) by rotating a spherical driving wheel by driving a plurality of omni wheels and easily move regardless of a topography form with a movement according to a rolling movement of the driving wheel.

A multipurpose rollable moving device can mount and move various kinds of articles regardless of a size and kind of an article via a docking portion having a magnet that is mounted within a driving wheel and a mounting portion that is detachably coupled to the docking portion through a magnetic force at the outside of the driving wheel.

Because a person may directly sit on the mounting portion or mount, and sit, move an appropriate sitting means such as a chair, the multipurpose rollable moving device can be used even as a smart mobility device, mount a camera or a smart device, photograph a disaster site or a rescue site in which a person cannot approach, and directly perform or assist a disaster and rescue activity by moving to a disaster and rescue site by mounting a rescue mechanism or equipment.

Further, the multipurpose rollable moving device can be used even for an exercise such as personal fitness or health care, as a moving means such as a personal secretary robot, and even for a baby's play or education.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a multipurpose rollable moving device in an exemplary form of the present disclosure;

FIG. 2 is a bottom view of a multipurpose rollable moving device in an exemplary form of the present disclosure;

FIG. 3 is a perspective view of a docking portion of a multipurpose rollable moving device in an exemplary form of the present disclosure;

FIGS. 4A and 4B are exploded perspective views of a driving device of a multipurpose rollable moving device in an exemplary form of the present disclosure;

FIG. 5 is a perspective view of a mounting portion of a multipurpose rollable moving device in an exemplary form of the present disclosure;

FIG. 6 is a flowchart illustrating a method of controlling a multipurpose rollable moving device in an exemplary form of the present disclosure; and

FIG. 7 is a diagram illustrating a state in which a multipurpose rollable moving device is received and charged within a vehicle in an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

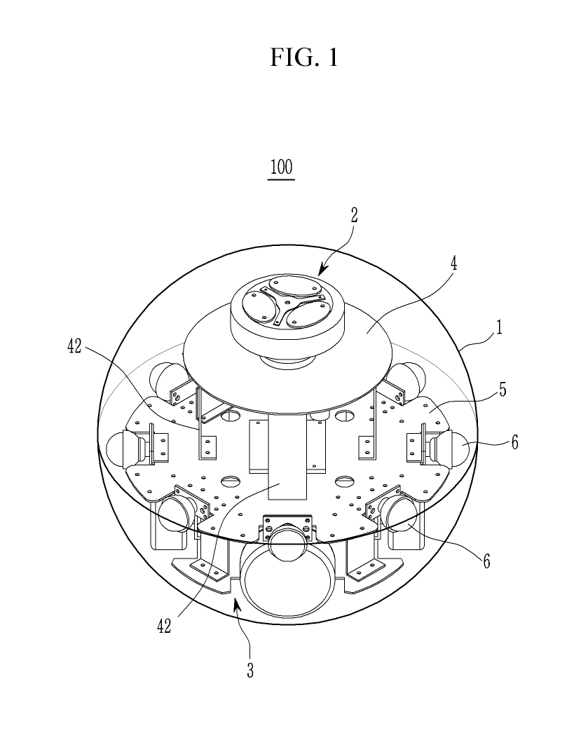

FIG. 1 is a perspective view of a multipurpose rollable moving device in one form of the present disclosure. Referring to FIG. 1, a multipurpose rollable moving device 100 may include a spherical driving wheel 1. The driving wheel 1 may be made of a non-magnetic material, and a predetermined size of receiving space may be formed within the driving wheel 1.

In an upper portion of an inner receiving space of the driving wheel 1, a docking portion 2 may be disposed, and in a lower portion thereof, a driving device 3 may be disposed.

The docking portion 1 may be mounted on a first mounting plate 4 of generally a circular plate shape, in a central portion of an inner receiving space of the driving wheel 1, a second mounting plate 5 of a circular plate shape may be disposed, the first mounting plate 4 may be connected with the second mounting plate 5 through a plurality of bridges 42, and the docking portion 2 may be supported on the second mounting plate 5 through the first mounting plate 4 and the bridge 42.

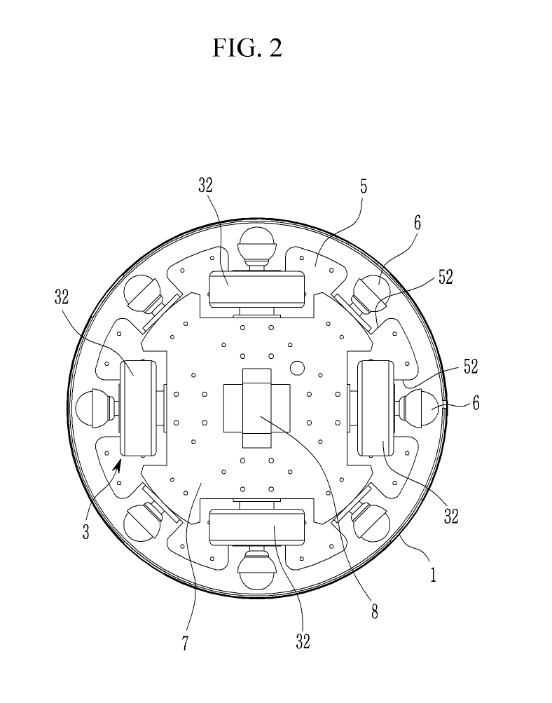

FIG. 2 is a bottom view of a multipurpose rollable moving device in an exemplary form of the present disclosure. Referring to FIG. 2, plurality of receiving grooves 52 are formed at a predetermined gap in a circumference direction of the second mounting plate 5, and a ball castor 6 is housed in each receiving groove 52.

The ball castor 6 inhibits or prevents interference with the second mounting plate 5 when the driving wheel 1 performs a rolling movement while rotating and enables the driving wheel 1 to be rotatably supported in the second mounting plate 5.

A third mounting plate 7 may be disposed under the second mounting plate 5, and the driving device 3 may be mounted and supported in the third mounting plate 7.

Further, at a central portion of a lower surface of the third mounting plate 7, a battery pack 8 may be mounted, and the battery pack 8 may supply power to the driving device 3 and may be charged from the outside.

The battery pack 8 is positioned at a lower portion of the driving wheel 1 to perform a mass center function.

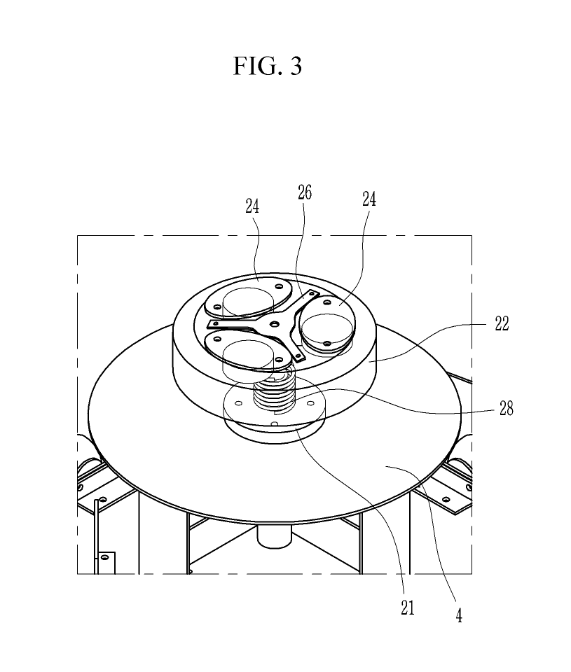

FIG. 3 is a perspective view of a docking portion of a multipurpose rollable moving device in an exemplary form of the present disclosure. Referring to FIG. 3, the docking portion 2 may include a docking housing 22, a plurality of magnets 24 that is mounted at an upper portion of the docking housing 22, a support shaft 26 that inserts and supports the docking housing 22, and a spring 28 as an elastic member for elastically supporting the support shaft 26.

A lower portion of the support shaft 26 may be inserted into a fourth mounting plate 21 of a circular plate shape, and the fourth mounting plate 21 may be assembled in the first mounting plate 4 by a bolt.

The plurality of magnets 24 is a permanent magnet and may be replaced with an electromagnet, as needed, has a structure in which three magnets 24 are disposed at a predetermined gap in a circumference direction, but may be configured with at least two magnets 24.

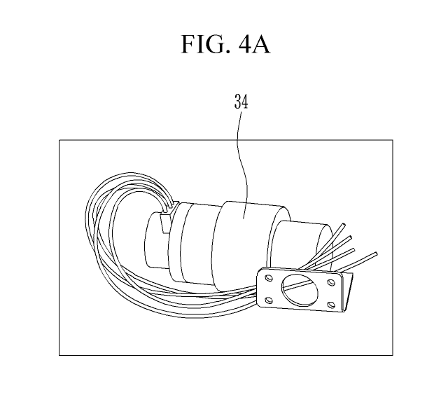

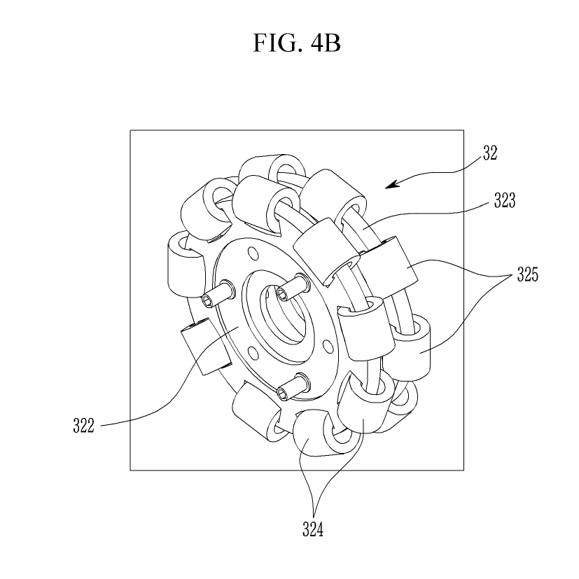

FIGS. 4A-4B are exploded perspective views of a driving device of a multipurpose rollable moving device in one form of the present disclosure. Referring to FIGS. 4A and 4B, the driving device 3 may include a plurality of omni wheels 32 and a drive motor 34 that is coupled to the omni wheel 32 in order to drive the omni wheel 32.

The omni wheel 32 may include two wheel housings 322 and 323 of generally a circular plate shape and a plurality of first and second rollers 324 and 325 that are rotatably mounted in respective wheel housings 322 and 323.

The two wheel housings 322 and 323 may be disposed in an axial direction to form a two-fold housing.

In the first wheel housing 322, a plurality of first rollers 324 may be disposed at a predetermined gap in a circumference direction, and in the second wheel housing 323, a plurality of second rollers 325 may be disposed at a predetermined gap in a circumference direction.

Further, each second roller 325 may be disposed between a plurality of first rollers 324 in a circumference direction.

Further, although not shown in detail, an encoder may be installed in each omni wheel 32 to detect a rotation speed of the omni wheel 32.

Referring again to FIG. 2, a plurality of omni wheels 32 may be disposed in four omni wheels in an angle of 90° in a circumference direction.

When each omni wheel 32 receives a torque and rotates through the drive motor 34, each roller of the omni wheel 32 rotates, and the driving wheel 1 that comes in close contact with each roller receives a torque and rotates through the each roller and rolling moves.

When controlling operation of each drive motor 34 of each omni wheel 32, the driving wheel 1 may rotate in place as well as be capable of rolling over in all directions (i.e., an omnidirection).

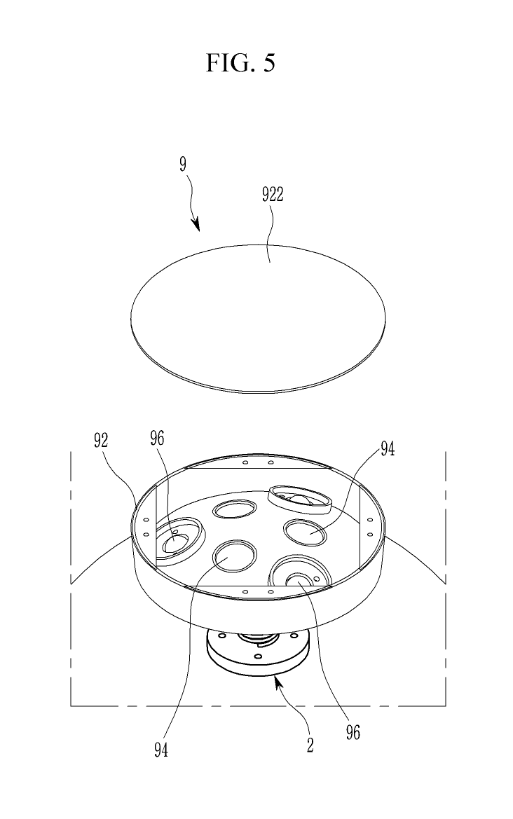

FIG. 5 is a perspective view of a mounting portion of a multipurpose rollable moving device in an exemplary form of the present disclosure. Referring to FIG. 5, a multipurpose rollable moving device may further include a mounting portion 9 that can detachably couple to the docking portion 2.

Because the mounting portion 9 is put on a surface of the driving wheel 1 and is coupled to the docking portion 2 through a magnetic force, even if the driving wheel 1 performs a rolling movement, the mounting portion 9 may be always positioned at an upper portion of the driving wheel 1 as long as the docking portion 2 maintains a proper position.

The mounting portion 9 may include a mounting housing 92 that generally forms a disc, a plurality of magnets 94 that is received within the mounting housing 92 to mutually operate with the magnet 94 of the docking portion 2, and a plurality of ball castors 96 that is mounted at a lower surface of the mounting housing 92 and contacts with a surface of the driving wheel 1 in order not to rub with the mounting housing 92 when the driving wheel 1 rotates.

Various articles may be mounted on a flat mounting plate 922 that forms an upper surface of the mounting housing 92.

For example, the multipurpose rollable moving device may mount and move a smart device (e.g., a smart phone or a navigation device), or a camera to take pictures of its surroundings, and also mount and move several devices or equipment. In addition, the multipurpose rollable moving device mounts a chair so as for a person to sit on the chair or enables a person to directly sit on a mounting portion, and thus the multipurpose rollable moving device can be used for various use, for example, a personal moving means.

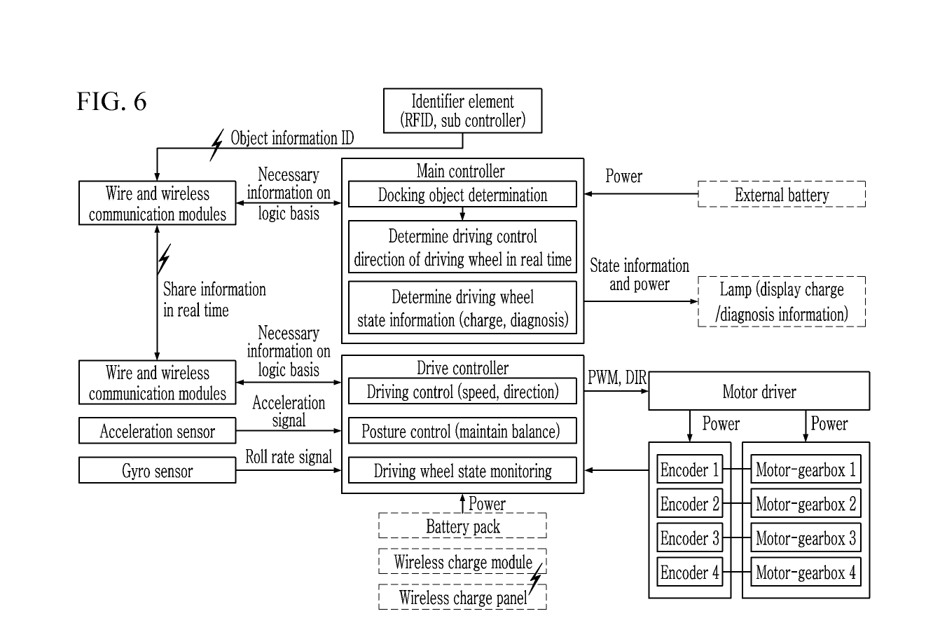

FIG. 6 is a flowchart illustrating a method of controlling a multipurpose rollable moving device in an exemplary form of the present disclosure. Referring to FIG. 6, in the mounting portion 9, in order to identify a mounted object, an identifier element may be installed. As an identifier element, for example, Radio Frequency Identification (RFID) may be used. The identifier element may identify a mounted object, and in order to transmit identification information of the identified object, a sub controller may be housed in the mounting portion 9.

A main controller may be installed in the second mounting plate 5. The main controller may receive information of a mounted object from an identifier element or a sub controller through wire and wireless communication modules and identify the mounted object. (Docking object determination)

When a camera is mounted in the driving wheel, the main controller may determine a surrounding situation of the driving wheel 1 through a camera image and determine in real time a driving control direction based on the determination.

Further, the main controller may be connected with the battery pack 8 to determine and diagnose state information of the driving wheel 1, for example a charge state of the battery pack 8.

In the third mounting plate 7 in which the driving device 3 is mounted, a drive controller may be installed.

The drive controller may be connected with a motor driver of the drive motor 34 to control a driving speed (PWM control) and a driving direction (DIR control) of the drive motor 34. In this case, the drive controller may determine and feedback a rotation speed of the drive motor 34 through the encoder.

Further, an acceleration sensor and a gyro sensor are installed in the driving wheel 1, the drive controller may determine a rolling moving speed and a rotation speed of the driving wheel 1 through the acceleration sensor to control a drive motor and determine a roll rate signal through the gyro sensor to control a posture of the driving wheel to maintain balance.

The drive controller may communicate with a main controller through wire and wireless communication modules to share information in real time.

The battery pack 8 may receive a wireless charge module.

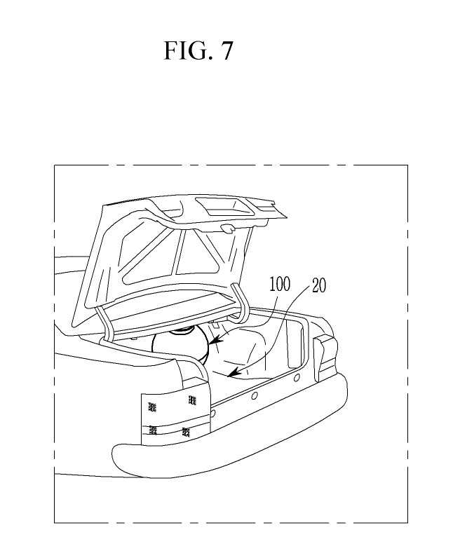

FIG. 7 is a diagram illustrating a state in which a multipurpose rollable moving device is received and charged within a vehicle according to an exemplary form of the present disclosure. As shown in FIG. 7, the battery pack 8 may be received within a trunk room 20 of a vehicle to move through the vehicle and communicate by wireless with a wireless charge panel of the vehicle in a state that is received in the trunk room 20 to charge the battery pack 8.

While this present disclosure has been described in connection with what is presently considered to be practical example forms, it is to be understood that the present disclosure is not limited to the disclosed forms, but, on the contrary, is intended to cover various modifications and equivalent arrangements included within the spirit and scope of the present disclosure.

What is claimed is:

1. A multipurpose rollable moving device, comprising:
a spherical driving wheel;
a driving device that is installed within the spherical driving wheel and and configured to apply a torque to the spherical driving wheel;
a docking portion that is installed within the spherical driving wheel and configured to generate a magnetic force; and
a mounting portion attached to a surface of the spherical driving wheel by a magnetic force of the docking portion and configured to mount an article.

2. The multipurpose rollable moving device of claim 1, wherein in the mounting portion, a plurality of magnets configured to mutually operate with the magnetic force of the docking portion is provided.

3. The multipurpose rollable moving device of claim 2, wherein the mounting portion comprises:
a mounting housing;
the plurality of magnets that are received within the mounting housing; and
a plurality of ball castors mounted at a lower surface of the mounting housing and configured to contact a surface of the spherical driving wheel.

4. The multipurpose rollable moving device of claim 2, wherein the driving device comprises:
a plurality of omni wheels; and
a drive motor coupled to each of the plurality of omni wheels and configured to drive the plurality of omni wheels.

5. The multipurpose rollable moving device of claim 4, wherein the plurality of omni wheel comprises:
first and second wheel housings each having a circular plate shape; and
a plurality of first and second rollers that are rotatably mounted in the each of the first and second wheel housings.

6. The multipurpose rollable moving device of claim 5, wherein the first and second wheel housings are disposed in an axial direction to form a two-fold housing,
in the first wheel housing, the plurality of first rollers are arranged at predetermined intervals in a circumference direction,
in the second wheel housing, the plurality of second rollers are arranged at predetermined intervals in a circumference direction, and
the second rollers are disposed one by one between the plurality of first rollers.

7. The multipurpose rollable moving device of claim 4, wherein in each of the plurality of omni wheels, an encoder configured to detect a rotation speed is installed.

8. The multipurpose rollable moving device of claim 4, further comprising a drive controller configured to control the drive motor,
wherein the drive controller is connected with a motor driver of the drive motor and configured to control a driving speed and driving direction of the drive motor.

9. The multipurpose rollable moving device of claim 8, further comprising an acceleration sensor,
wherein the drive controller is configured to determine a rolling moving speed of the spherical driving wheel through the acceleration sensor to control the drive motor.

10. The multipurpose rollable moving device of claim 8, further comprising a gyro sensor,
wherein the drive controller is configured to determine a roll rate signal through the gyro sensor and configured to control a posture of the spherical driving wheel.

11. The multipurpose rollable moving device of claim 1, wherein the docking portion comprises:
a docking housing;
a plurality of magnets mounted at an upper portion of the docking housing and configured to generate the magnetic force;
a support shaft inserted into and configured to support the docking housing; and
a spring configured to elastically support the support shaft.

12. The multipurpose rollable moving device of claim 1, wherein the docking portion is mounted on a first mounting plate, and
in a central portion of an inside of the spherical driving wheel, a second mounting plate is disposed, and
wherein the first mounting plate is connected with the second mounting plate through a plurality of bridges.

13. The multipurpose rollable moving device of claim 12, wherein in the second mounting plate, a plurality of ball castors are installed at predetermined intervals in a circumference direction.

14. The multipurpose rollable moving device of claim 13, wherein a plurality of receiving grooves are formed at predetermined intervals in a circumference direction of the second mounting plate, and at least one ball castors of the plurality of ball castors is housed in each of the plurality of receiving grooves.

15. The multipurpose rollable moving device of claim 12, wherein a third mounting plate is disposed under the second mounting plate, and the driving device is mounted and supported on the third mounting plate.

16. The multipurpose rollable moving device of claim 12, wherein a battery pack is installed at a center of a lower surface of the third mounting plate, and configured to supply power to the driving device and be charged outside.

17. The multipurpose rollable moving device of claim 12, further comprising an identification element configured to identify an object that is mounted in the mounting portion.

18. The multipurpose rollable moving device of claim 17, further comprising a main controller configured to identify the object by communicating with the identification element through wire and wireless communication modules,
wherein the main controller is configured to diagnose a charge state of a battery pack.

19. The multipurpose rollable moving device of claim 17, wherein in the mounting portion, a camera is mounted, and the main controller is configured to determine a surrounding situation through the camera and to control the driving device.

20. The multipurpose rollable moving device of claim 12, wherein a battery pack is received within a trunk room of a vehicle and charged by wireless communication with a wireless charge panel of the vehicle.
